(19) United States
(12) Patent Application Publication
(10) Pub. No.: US 2026/0334394 A1
(43) Pub. Date: Oct. 29, 2026

(54) DEVICES AND METHODS FOR GROWING CROPS WITH NON-FIBROUS, NON-POROUS AND NON-CONSUMABLE SUBSTRATE

(71) Applicant: KAPPA AgTech, LLC, Vienna, VA (US)

(72) Inventor: Schuyler Milton, Vienna, VA (US)

(21) Appl. No.: 19/155,485

(22) PCT Filed: Feb. 24, 2024
(86) PCT No.: PCT/US24/17186

§ 371 Date: Aug. 11, 2025

Related U.S. Application Data
(60) Provisional application No. 63/448,286, filed on Feb. 25, 2023.

(51) Int. Cl. A01G 31/02

(52) U.S. Cl. CPC A01G 31/024

(57) ABSTRACT

A device and method for growing plants from seed, seedling, clone, root stock or young plant without the use of synthetic or natural fibers, fibrous media or porous media. The device comprises flexible non-fibrous, non-porous structures that support the seed, clone, plant or root stock during growth, while also establishing a delineation between the root zone and shoot zone of the plant. The device employs efficient use of material and breadth of applications within a single implementation.

### FIELD OF THE INVENTION

The present invention relates to novel devices, apparatus and methods for growing crops from seed, seedling, clone, plant or root stock without the use of fibrous or porous media, using reusable materials. Specifically, the invention relates to devices which enable growing from seed, clone or root stock using synthetic, polymeric non-woven, non-porous, non-fibrous materials which are not consumed in the growing process and which are capable of being cleaned and reused. The devices are applicable to a wide range of apparatus to grow crops in a variety of orientations, such as horizontal, vertical and angled, in hydroponic systems. The method relates to the use of the device and apparatus in planting, harvesting and cleaning to prepare for reuse.

### BACKGROUND OF THE INVENTION

Hydroponics encompasses the field of growing crops using nutrient rich water. Hydroponics includes various subsets, specifically, aeroponics, deep water culture (DWC), nutrient film technique (NFT) and flood-drain systems.

Hydroponics typically relies on the delivery of nutrient rich and oxygen rich water to plant roots. Seeds are typically germinated in a fibrous or porous growth media such as soil, soil composites with synthetic additives, or in woven or non-woven natural or synthetic fibers such as rockwool, peat, coconut coir, hemp, jute, phenolic foam or polyester. Typically, the germinated seeds, together with a portion of growth media, are then inserted or otherwise replanted into the hydroponic system once the seeds have germinated and the roots have infiltrated the growth media. The growth media serves as structural support for the germinating seeds, further providing structural support as the seedling grows. Importantly, the growth media serves a primary duty of wicking and retaining water to ensure proper germination.

All hydroponics systems that grow plants from seed to date employ a fibrous or porous media. Limitations of fibrous and porous media are as follows: (1) Fibrous and porous media may be consumed and therefore represent an ongoing economic cost to the process. For example, soils, natural fibers and non-woven fibers such as rockwool are not cleanable or reusable with substantial reprocessing prior to reuse. (2) Synthetic woven fibers such as polyester require extensive cleaning to remove plant matter interwoven in the fibers from the prior growing cycle. (3) Synthetic fibers such as rockwool and polyester cannot be certified as organic under USDA organic regulations or by parallel regulations in Canada, the European Union or Asia.

### SUMMARY OF THE INVENTION

The present invention relates to novel devices, apparatus and methods for growing crops from seed, seedling, clone, plant or root stock (herein “plants”). The device suspends seeds or plants in air such that the shoot system of the seed (once germinated), the plant, plant clone or the root stock is delineated from the root system. The device can be incorporated into a variety of apparatus for use in a horizontal plane, vertical plane, slanted plane, or multifaceted or circular column. The method comprises the steps to operate the apparatus including the steps by which seeds, plant clones or root stock are planted, grown and harvested, and steps by which the apparatus is cleaned and prepared for reuse.

### BRIEF DESCRIPTION OF THE DRAWINGS

The patent or application file contains at least one drawing and/or photograph executed in color. Copies of this patent or patent application publication with color drawing(s) will be provided by the Office upon request and payment of the necessary fee.

FIG. 1 (A-E) shows an example of one embodiment of the device from five views, A through E.

FIG. 2 (A-C) shows an example of one embodiments of the device from three different views, top angle (A), side (B), and from the bottom view (C).

FIG. 3 shows a full color example of one embodiment of the device in use with newly germinated plants.

### DETAILED DESCRIPTION OF THE INVENTION

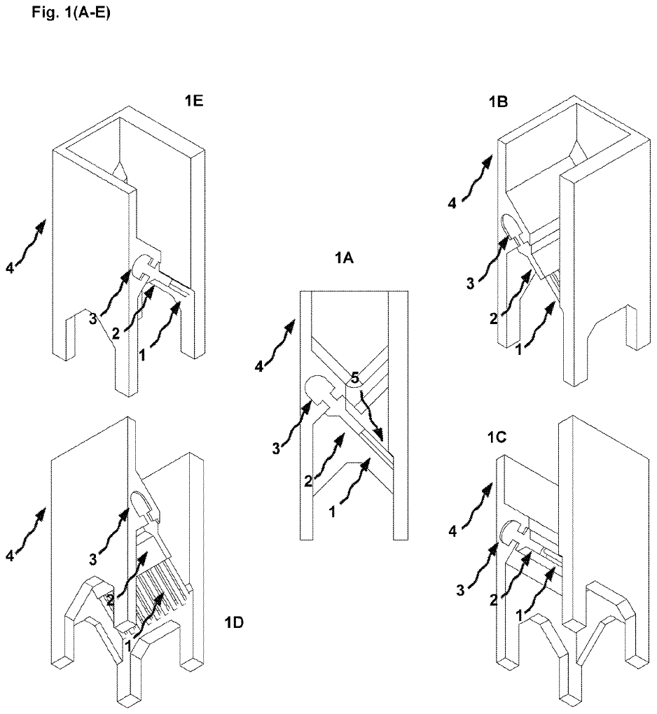

In one embodiment of the invention, the device, FIG. 1-3, is comprised of non-woven synthetic polymeric materials such as silicone rubber, nitrile, neoprene, vinyl, thermoplastic elastomers, ethylene propylene diene monomer, polypropylene, polyurethane, acrylonitrile butadiene styrene, acrylonitrile styrene acrylate and/or combinations thereof. The device cradles seeds or holds plants at the base of the stem, and/or top of the root system, at the delineation between the shoot system 5 (or shoot zone) and root system (or root zone). This is also a delineation between the area of the device from which the roots of plants held by the device may extend, and the area of the device from which the stem and foliage of plants held by the device will extend. The portion of the device forming the delineation between the shoot system and root system may be comprised, for example, of flexible silicone rubber protrusions 1, flaps 2 or a combination thereof as seen in FIG. 1 (A-E). When in use, this device allows water supplied to either side of the device to drain toward the root zone, with a small amount of water or nutrient solution held within the device via capillary action and surface tension.

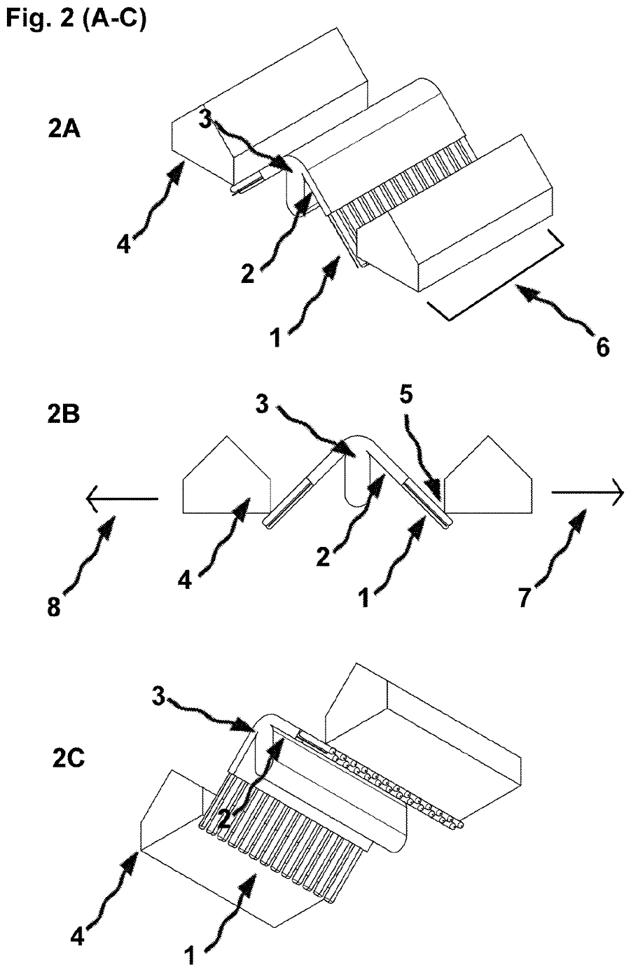

The protrusions 1, flaps 2 or a combination thereof as seen in FIG. 1 (A-E) and FIG. 2 (A-C) are held in place via a first rigid support structure 3 and held in opposition to a second rigid support structure 4. The first 3 and second 4 rigid support structures may form any shape desirable for the application, such as a rectilinear or cuboid shape seen in FIG. 1(A-E), or an elongated trough or tray shape as seen in FIG. 2(A-C). The trough or tray shape visualized in FIG. 2(A-C) is approximately 1-inch long in the lateral direction 6. This is device may extend to any length as desired for the application, with applications in industry ranging from less than 0.5-inches to more than 20-feet. Similarly, this device may form a repeating channel array by duplicating the features of the device in the right 7 and left 8 directions indicated in FIG. 2B. By extending and repeating this device in these directions, lateral, right and left, many different lengths and widths of this device are envisioned as appropriate for each application in horizontal, vertical and angled applications of hydroponics. Many other shapes and sizes of these structures are applicable to a wide range of use cases, including rounded or circular structures and long narrow vertical structures.

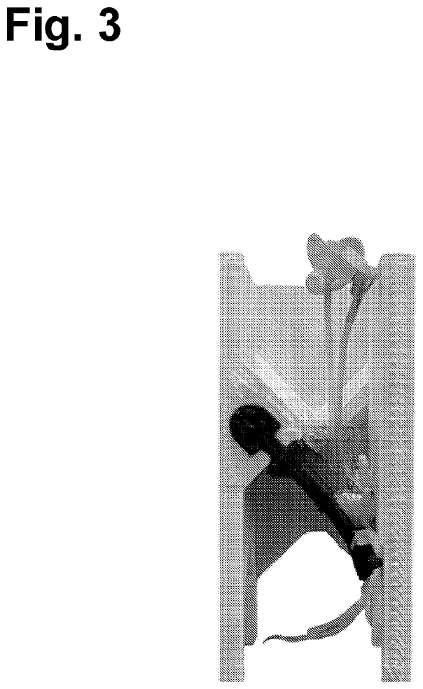

Improving significantly upon prior work done in this field, here it has been surprisingly found that a series combination of protrusions 1, together with flaps 2, form a surprisingly efficient method for producing the desired result. The combination uses far less material than previous attempts to implement similar features to hold seeds and plants in similar devices. The combination of a length of the flap 2 feature, terminating with a length of protrusions 1, held in opposition to a rigid support structure 4 has been surprisingly found to support seeds and plants of a wide range of sizes within a single device. This further contrasts with previous approaches that implemented short lengths of protrusions, in high density, held in opposition to eachother, or short lengths of protrusions held in opposition to lengths of flaps. Beyond routine optimization, this combination has surprisingly yielded a device which can cradle seeds of less than 1-mm in width and also be used with clones, maturing plants, and matured plants with stem widths up to the distance between the first support structure 3 and the second support structure 4. This has resulted in a generalized solution with surprising utility compared to the prior art. Further, the distance between the rigid structures of the device indicated by structural sections 3 and 4, and the flexible portions of the device, the protrusions 1 and flaps 2, enable the device to be cleaned easily, and similarly allows plants to be removed easily with root systems fully intact. This ease of use is possible because the flexible portion of the device, produced by combining the flap and protrusion features in series, can span a relatively wide distance compared to the devices used by the prior art and still exert resistance sufficient to suspend seeds, clones, and plants within the device. During cleaning, this wide distance enables large plant material to easily be washed through the device, and/or all or portions of a plant to be removed without damage. Furthermore, the device instantly described may incorporate an open end, as visualized in FIG. 1 (A-E) and FIG. 3. This open end allows plants ready for harvest, transplant or removal, to be removed easily from the device without damage by sliding the plant laterally out of the opening.

Seeds may be placed on the device on the shoot zone side of the device at the position at which the flexible portion of the device meets the second rigid support structure indicated in the figures at position 5, resting on the protrusions forming the delineation. When the device is used for growing plant clones, root stock, seedlings or plants, these are inserted through the delineation zone such that the root of the plant is on the root zone side of the device and the stem or foliage of the plant is on the shoot zone side of the device. The protrusions are spaced appropriately and comprised of sufficiently rigid material to prevent the seeds, germinated seeds, plant clones, root stock, seedlings or plants from passing through the delineation zone under their own weight. Similarly, the protrusions must be comprised of sufficiently flexible material to allow the plants to grow through the delineation zone and to allow insertion of plant clones, root stock, seedlings or plants without damage to the device or plants. Upon seed germination, the newly germinated root will continue to grow into the root zone (watered side) where nutrient rich water is provided and the shoot system will continue to grow into the shoot zone (air side) where exposure to light and circulated air is provided.

According to an embodiment of the invention, plant clones such as basil cuttings may be grown using the device. The stem of the plant clone can be inserted into the device through the delineation zone such that the cut stem where the root zone is intended to develop is on the root zone side of the device, which the stem being held in place by the pressure exerted by the flexible protrusions 1, flaps 2 or a combination thereof, against an adjacent rigid material 4.

According to an embodiment of the invention, root stock such as from strawberries may be grown using the device. The root portion of the root stock can be inserted into the device through the delineation zone such that the root system is on the watered side of the device and the shoot system is on the shoot zone side.

According to an embodiment of the invention, the device may be provided water from the shoot zone side, such that the water drains into the device through the delineation zone to reach the root zone.

Water may be provided from the shoot zone side of the device during initial planting, such as during the germination process for newly planted seeds, or continuously.

According to an embodiment of the invention, the device is oriented relative to the ground such that water provided from the shoot zone side will drain into the device passing through the delineation zone into the watered side.

According to an embodiment of the invention, the device is oriented relative to the ground such that water provided from the watered side does not substantially pass through the delineation zone and remains or drains from the watered side of the device.

According to an embodiment of the invention, the device can be incorporated into a horizontal apparatus to enable hydroponic growing via DWC, NFT, flood-drain or aeroponics.

According to an embodiment of the invention, the device can be incorporated into vertical apparatus to enable hydroponic growing via NFT, drip watering, or aeroponics.

According to an embodiment of the invention, the device can be incorporated into angled apparatus to enable hydroponic growing via NFT, drip watering, or aeroponics.

According to an embodiment of the invention, the device can be used with hydroponic systems using synthetic, natural, combination or aquaponic nutrient enriched water.

According to an embodiment of the invention, when the crops are ready to harvest a cutting tool may be applied across the foliar portion to cut the grown crops from the remaining portion of the plant body.

According to an embodiment of the invention, when the crops are ready to harvest or be removed from the device, the plants may be removed from the device by sliding laterally out the open end of the device.

According to an embodiment of the invention, after the harvest of the edible portion of the crop the device may be washed with high-pressure washing to remove all plant material.

According to an embodiment of the invention, the device is comprised of UV-stable materials.

According to an embodiment of the invention, the device is comprised of materials resistant to common methods of sterilization, including heat and chemical sterilizers common in the art.

1. A device for supporting a seed, seedling, clone, root stock, or plant, in a hydroponic system, comprising:
a first rigid support structure to which a first flexible portion is attached by a means for attaching,
wherein the first flexible portion is comprised of a synthetic material that is both non-fibrous and non-porous,
wherein the first flexible portion forms a delineation between an outer facing region and an inner facing region of the device,
wherein the inner facing region is proximal to a source of irrigation supplied by the hydroponic system, and the outer facing region is distal, relative to the inner facing region, to the source of irrigation supplied by the hydroponic system,
wherein the first flexible portion comprises (a) a flexible flap extending from the means for attaching, or (b) a plurality of flexible protrusions extending from the means for attaching, or (c) a combination thereof wherein the flap extends from the means for attaching and the protrusions extend from the end of the flap distal to the means for attaching,
and wherein the first flexible portion of the device is sufficient to support a seed, seedling, clone, root stock or plant such that when the device is in use, the seed, seedling, clone, root stock or plant cannot pass through the delineation under its own weight.

2. The device of claim 1, wherein a portion of the first flexible portion of the device, distal to the means for attaching the first flexible portion to the device, makes contact with a second rigid support structure at one or more points, wherein the second rigid support structure is on an opposing facet of the device.

3. The device of claim 2, wherein the seed, seedling, clone, root stock, or plant rests at or between a point of contact between the distal end of the first flexible portion and the second rigid support structure.

4. The device of claim 1, wherein the first flexible portion of the device consists of a plurality of flexible protrusions extending from the means for attaching,
and wherein a seed placed in the device will rest on or between the protrusions at (a) an area proximal to the means for attaching, or (b) an area distal to the means for attaching, or (c) a point in between the proximal and distal ends of the protrusions.

5. The device of claim 1, wherein the device comprises a second flexible portion comprising (a) a flexible flap extending from the means for attaching, or (b) a plurality of flexible protrusions extending from the means for attaching, or (c) a combination thereof wherein the flap extends from the means for attaching and the protrusions extend from the end of the flap distal to the means for attaching,
and wherein the first and second flexible portions are attached to the rigid structure of the device on opposing facets of the rigid structure such that the ends of the first and second flexible portions distal to their respective means for attaching make contact with the opposing flexible portion at one or more points,
and wherein a seed, seedling, clone, root stock, or plant rests at or between a point of contact between the first and second flexible portions.

6. The device of claim 3, wherein a seed placed into the device, resting at or between a point of contact between the distal end of the first flexible portion and the second rigid support structure, will germinate in the device when exposed to water.

7. The device of claim 4, wherein a seed placed into the device, on or between the protrusions at an area proximal to the means for attaching, distal to the means for attaching, or at a point in between the proximal and distal ends of the protrusions, will germinate in the device when exposed to water.

8. The device of claim 5, wherein a seed placed into the device resting at or between a point of contact between the opposing first and second flexible portions, will germinate when exposed to water.

9. A method for growing plants from seed, seedling, clone, root stock, or transplanted plant, in a hydroponic system, the method comprising, placing a seed, seedling, clone, root stock, or transplanted plant into a device for supporting the growth of the seed, seedling, clone, root stock, or transplanted plant, the device comprising:
a first rigid support structure to which a first flexible portion is attached by a means for attaching,
wherein the first flexible portion forms a delineation between an outer facing region and an inner facing region of the device,
wherein the inner facing region is proximal to a source of irrigation supplied by the hydroponic system, and the outer facing region is distal, relative to the inner facing region, to the source of irrigation supplied by the hydroponic system,
wherein the first flexible portion comprises (a) a flexible flap extending from the means for attaching, or (b) a plurality of flexible protrusions extending from the means for attaching, or (c) a combination thereof wherein the flap extends from the means for attaching and the protrusions extend from the end of the flap distal to the means for attaching,
and wherein the first flexible portion of the device is sufficient to support a seed, seedling, clone, root stock or plant such that when the device is in use, the seed, seedling, clone, root stock or plant cannot pass through the delineation under its own weight,
and wherein the seedling, clone, root stock, or transplanted plant is oriented in the device such that the root system of the seedling, clone, root stock, or transplant plant is substantially in the inner facing region of the device and the shoot system of the seedling, clone, root stock or transplanted plant is substantially in the outer facing region of the device.

10. The method of claim 9, wherein (1) a seed is placed into the device, (2) water is applied to the seed, and (3) the seed germinates in the device with the root of the germinating seed extending into the inner facing region of the device.

11. The method of claim 9, wherein a first portion of a plant supported by the device is removed by cutting, followed by a remaining portion of the plant being removed by pulling, or washing, or a combination thereof.

12. The method of claim 9, wherein no growth media is used in combination with the device.

13. The method of claim 9, wherein growth media is used in combination with the device.

14. The method of claim 9, wherein seeds less than 1 millimeter in width do not pass through the delineation under their own weight.

15. The method of claim 9, wherein seeds greater than 1 millimeter in width do not pass through the delineation under their own weight.

16. The method of claim 9, wherein the device is used in a hydroponics system selected from the group consisting of, a deep water culture system, a nutrient film technique system, a flood-drain system, and an aeroponics system.
